(19) United States
(12) Patent Application Publication
(10) Pub. No.: US 2010/0000148 A1
(43) Pub. Date: Jan. 7, 2010

(54) Concrete Mulch

(76) Inventor: Michael D. Flynn, Lawrenceville, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 12/338,165

(22) Filed: Dec. 18, 2008

Related U.S. Application Data
(60) Provisional application No. 61/007,548, filed on Jul. 3, 2008.

(51) Int. Cl. A01G 13/00; B28C 7/00

(52) U.S. Cl. 47/9; 366/6

(57) ABSTRACT

The present invention relates to concrete mulch and methods for making the same. The concrete mulch is made from crushed waste concrete, a colorant and a binder which colors the concrete pieces to look like natural mulch. The concrete mulch is available in a wide variety of shapes and sizes; however, it is preferred for the concrete mulch to look like natural rock, bark nuggets or natural mulch.

### CROSS-REFERENCE TO RELATED APPLICATIONS

The present application claims the benefit of and priority to U.S. Provisional Application No. 61/007,548 filed Jul. 3, 2008, titled “Concrete Mulch”, which is herein incorporated by reference.

### TECHNICAL FIELD

The present invention relates generally to landscape materials and, more particularly, to materials used for mulch.

### BACKGROUND OF THE INVENTION

Mulch is a protective covering material that is typically placed on top of soil and which is used in association with ornamental lawns, gardens and landscape settings. Often the mulch material is placed around trees, shrubs, and flowers to give a pleasing appearance and to prevent the evaporation of water from around the trees, shrubs and flowers. In general mulch is any of a variety of materials which are used to prevent evaporation of water, protect roots from freezing, and retard the growth of weeds. The mulch material retards the growth of weeds by preventing sunlight from reaching the surface of the ground, which prevents the growth of many plants. Also, the mulch forms a barrier many plant species cannot penetrate. Freezing of roots is prevented because the mulch functions similar to insulation. The mulch prevents evaporation by preventing the surface from being directly contacted by sunlight.

Most mulch is made from bark shredded wood, wood chips, small chunks of bark, and sawdust, which are processed from trees, and virgin rock, which is strip mined from quarries. One problem associated with the use of wood-based mulch and rock mulch is the adverse affect on the environment when the trees are cut and rock aggregate is strip-mined. Further, wood based mulch has additional drawbacks including pest, insect and disease problems in the landscape environment and a short useful life as they decompose rapidly. Diseased and insect infested trees are often used as base material in wood mulch products.

At the same time, in every geographic region of the world massive quantities of post-consumer product waste are being disposed of in landfills, which are filling up rapidly. Much energy is utilized in producing consumer products and in disposing of post-consumer waste. To be able to constructively and effectively utilize post-consumer waste for landscaping applications would extend the useful life of such products and impede the problems associated with landfill capacity.

Thus, there exists a need in the art for a mulch product that utilizes consumer waste, has the aesthetic characteristics of wood or virgin stone aggregate mulch, and is pest and disease resistant. It is to the provision of such that the present invention is directed.

### BRIEF SUMMARY OF THE INVENTION

The invention relates to the use of post-consumer content concrete as the primary feedstock for manufacturing mulch. The use of post-consumer content concrete as mulch is another means to address the growing world wide waste issue by reducing the amount of post-consumer content concrete being disposed of in landfills. Post-consumer content concrete includes demolished concrete airport runways, curb and gutter systems, interstate highway road beds, old out-of-date bridges, buildings and infrastructure; thus, there is much availability of this feedstock for producing mulch. Recycled concrete used as mulch extends the concrete life cycle and salvages the existing embedded energy as a useful product. Further and of equal importance, concrete provides for a mulch product which is insect and disease resistant, made from recycled aggregates, retains moisture, prevents growth of weeds, does not break down, and can be colored to produce concrete mulch of a variety of different colors with the appearance of natural mulch.

Preferably, the present-invention relates to concrete mulch, methods for making the concrete mulch and uses of concrete and colorants to make concrete mulch. The concrete mulch of the present invention is comprised of concrete pieces, a colorant and binder. The concrete pieces preferably have a diameter equal to at least ⅛ inches. The concrete pieces are produced from a variety of waste concrete by means of chipper, shredder, hammer mill, pulverizer, jaw crusher or the like. The surface of the concrete pieces will preferably have tumbled edges which gives the concrete pieces a feel and appearance of natural mulch. The colorant used to color concrete pieces can be any iron-oxide, carbon black or acrylic colorant. The binder is preferably a polymeric binder, such as polyvinyl acetate. The resulting concrete mulch is an aesthetically pleasing landscaping ground cover that effectively and productively disposes of post-consumer waste.

### BRIEF DESCRIPTION OF THE DRAWINGS

FIG. 1 and FIG. 2 are cross-sectional views of concrete mulch pieces designed to look like natural virgin aggregate and natural wood bark mulch nuggets.

### DETAILED DESCRIPTION OF THE INVENTION

In accordance with the preferred invention concrete mulch is provided which is shaped and sized to look like natural rock aggregate, as well as, a method for making the concrete mulch from recycled concrete waste. The concrete mulch is especially desirable because it is designed and dimensioned to look like natural rock so that it has an attractive appearance. The concrete mulch is also desirable because it functionally holds moisture in the soil that is covered by the concrete mulch, prevents weed growth, is not hazardous, does not attract insects, and provides protection for roots. The use of concrete to form mulch is especially significant because concrete, unlike other natural mulches, is available as recycled post consumer content that may be crushed and dimensioned to look like natural rock and is easily colored. Further, the concrete mulch of the present invention appears to retain more moisture than natural rock because of porous surface of the concrete.

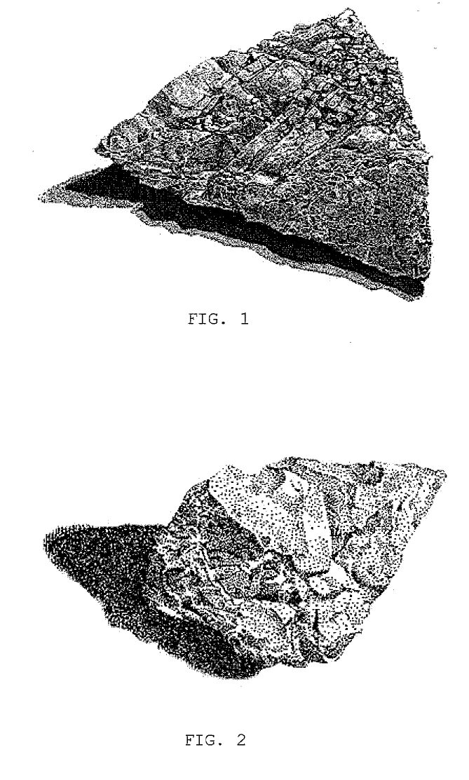

The concrete mulch is made by coloring the surface of a plurality of concrete pieces with iron-oxide based colorants, carbon black based colorants, and/or acrylic colorants blended with a binder. Concrete is crucial to the present invention because of the unique and desirable characteristics imparted by concrete and because of its ease of use. The concrete pieces used may be a variety of sizes, shapes and texture. To its benefit, the concrete pieces used can be crushed or shredded to resemble natural rock (as shown in FIG. 1 and FIG. 2), and a variety of other natural mulches as the concrete particles can de shaped and textured in a variety of ways.

The method for forming the surface of the concrete pieces can involve any variety of methods. Most likely, the surface of the concrete pieces is formed by passing waste concrete from demolition of structures and pavements through a machine that crushes and contours the concrete pieces. The waste concrete prior to formation into concrete pieces is in large chunks approximately two (2) feet wide and about two (2) feet long. The waste concrete is passed through a machine which crushes the waste concrete into concrete pieces, which have a smooth or contoured surface and have a variety of length and thickness. The machine may be a chipper, shredder, hammer mill, pulverizer, jaw crusher or the like. In one embodiment, large pieces of waste concrete are down sized using an excavator with a demolition tool impact/jaw type crusher. The material is fed into a hopper and passed through a jaw crusher at a rate of 30-100 tons per hour. Upon exiting the jaw crusher, the material is filtered using two-way material segregation screens having opening dimensions of 1.25 inches. Material greater than 1.25 inches is separated and piled using conveyors for further processing. Material that is smaller than 1.25 inches falls through the screen and is collected. The material, now being greater than about 1.25 inches, is fed through a screening machine with a 2.0 inch screen. Material greater than 2.0 inches is separated and collected. Material, which fell through the 2.0 inch screen, is collected and used as the concrete pieces to form the concrete mulch.

Preferably, the concrete pieces have a length ranging between about ⅛ inches and about seven (7) inches and a width ranging between about ⅛ inches and seven (7) inches. A variety of sizes can be used, however, dependent on the specific natural rock and mulch it is desired to imitate once the concrete pieces are formed from the waste concrete.

The concrete pieces are placed in means for mixing the concrete pieces with a colorant and binder. Any variety of mixing means can be used so long as the device chosen can adequately mix the concrete pieces with the colorant and binder. After the concrete pieces are placed in the mixing means, an amount of colorant is added to the concrete pieces in the mixing means. The amount of colorant will be equal to between about 0.0025% and about 5%, preferably 0.0025% and about 2%, by weight of the concrete pieces. The amount of binder will be equal to between about 0.0025% and about 5%, preferably about 0.0025% and about 2%, by weight of the concrete pieces. More preferably, the colorant and binder are each added in an amount equal to between about 0.0025% and about 0.005% by weight of the concrete pieces. The colorant and binder can each also be added according to volume of the concrete pieces of from about 0.002% to about 7%, preferably about 0.002% to about 3% by volume of the concrete pieces. More preferably, the volume of colorant and binder added to the concrete pieces is equal to between about 0.003% and about 1% by volume of the concrete pieces. Once the colorant and binder is added, the materials are thoroughly mixed so as to ensure that the concrete pieces are fully coated with the colorant and so that the concrete mulch will be uniformly colored. Any mixing time is permissible so long as the surfaces of the concrete pieces are uniformly colored to form the concrete mulch. When mixing between concrete pieces, colorant and binder is completed, the resulting material needs to be dried so as to ensure that the final product of the concrete mulch will retain its color when used. If complete drying of the concrete mulch is not accomplished, then the concrete mulch will not hold its color. Typically it takes between one (1) minute and two (2) hours to complete the drying process which is accomplished by means of an aggregate dryer. The drying means can be of any of a variety of devices. Suitable drying means also includes simply allowing the concrete mulch to air dry at room or ambient outdoor temperature.

The colorant used to color the concrete pieces can be selected from a variety of different coloring systems, as long as the colorant is available in at least earth tone colors, adheres to concrete, and does not wash off the concrete when contacted by water. The preferred colorants are iron-oxide based colorants, carbon black based colorants and/or acrylic colorants. More preferably, the colorant is selected from iron-oxide based colorants, carbon black based colorants and mixtures thereof. One such colorant is available and sold under the trade name Rock Magic®, by ColorBiotics, a Becker Underwood Company, located in Ames, Iowa. The binder used is preferably a polymer binder, and more preferably, polyvinyl acetate. One such binder is available and sold under the trade name Secure(Polymer 67C), by Becker Underwood Company of Ames, Iowa. The materials are preferred because they are available in earth tones and a variety of other colors. Additionally, other colorant and binder systems can be used so long as the colorants remain on the concrete mulch when exposed during long term outside use and so long as the concrete mulch is suitably colored.

Once formed the concrete mulch is placed in the landscape setting around trees, shrubs and flowers or used as edging and/or border material to enhance the appearance of a landscape. As mentioned, the concrete mulch will protect certain trees, shrubs and flowers and keep weeds from growing by blocking the sunlight needed for weed seeds to germinate. Additionally concrete mulch can be sized, shaped and colored so the surface is desirable to the user.

### EXAMPLE

An amount of concrete mulch for use in a landscape setting was prepared by placing in a thirty (30) gallon plastic drum an amount of colorant, binder and concrete pieces. The concrete pieces were derived from waste concrete. The concrete pieces have a length ranging between ⅛ inches and about seven (7) inches and a width ranging between ⅛ inches and about seven (7) inches. The concrete pieces were added to the drum in an amount equal to 75 pounds.

After the concrete pieces were added to the plastic drum an amount of colorant and binder was then added to the concrete pieces in the plastic drum. The colorant added was canyon brown and is manufactured by ColorBiotics, a division of Becker Underwood Company of Ames, Iowa, under the trade name Rock Magic® and the binder was polyvinyl acetate and is manufactured by Becker Underwood Company of Ames, Iowa under the trade name Secure(Polymer 67C). The amount of colorant and binder each added to the plastic drum was equal to 0.05 pounds or 0.0025% by weight of the concrete pieces.

After the colorant and binder were added to the plastic drum and the constitutes were hand mixed by sealing the drum and rolling the drum on a concrete surface for three (3) minutes, which is sufficient to thoroughly coat the concrete pieces with the colorant system. After mixing, the concrete pieces were removed from the plastic drum, spread out and allowed to air dry for one (1) hour. After drying the concrete mulch was formed and ready for use.

In this way, there has been shown and described a novel concrete mulch, which fulfills all the objectives and advantages sought therefore. It would be apparent to one of ordinary skill in the art, however, that many changes, variations modification, and other uses and applications for the subject method and composition are possible, and also such changes, variations, modifications and other uses and applications which do not depart from the spirit and scope of the invention are deemed to be covered by the invention which is limited only by the claims.

What is claimed is at least:

1. A material for use as landscaping mulch and ground cover comprising concrete pieces obtained from waste concrete, a colorant and a binder; wherein said material is sized, shaped and colored to imitate natural mulch pieces of natural rock aggregates or natural wood bark nuggets thus forming concrete mulch.

2. The material of claim 1 wherein said concrete pieces have a length ranging from about ⅛ inches to about 7 inches and a width ranging from about ⅛ inches to about 7 inches.

3. The material of claim 1 wherein said colorant is selected from the group consisting of iron oxide colorant, carbon black colorant and mixtures thereof.

4. The material of claim 1 wherein the colorant is present in an amount ranging from about 0.0025% to about 5% by weight of said concrete pieces.

5. The material of claim 1 wherein the colorant is present in an amount ranging from about 0.0025% to about 2% by weight of said concrete pieces.

6. The material of claim 1 wherein said binder is a polymer.

7. The material of claim 1 wherein said binder is a polyvinyl acetate.

8. The method of claim 1 wherein the amount of binder added is from about 0.0025% to about 5% by weight of said concrete pieces.

9. The method of claim 1 wherein the amount of binder added is from about 0.0025% to about 2% by weight of said concrete pieces.

10. A concrete mulch comprising concrete pieces have a length ranging from about ⅛ inches to about 7 inches and a width ranging from about ⅛ inches to about 7 inches; a colorant selected from the group consisting of iron oxide colorant, carbon black colorant and mixtures thereof; and a polyvinyl acetate binder.

11. The concrete mulch of claim 10 wherein said concrete pieces are waste concrete.

12. A method of forming concrete mulch comprising the steps of:
a) crushing an amount of concrete to form a plurality of concrete pieces ranging in size of from about ⅛ inch to about 7 inches,
b) adding a colorant and a binder to said concrete pieces, and
c) mixing said colorant and said binder with said concrete pieces to uniformly distribute the colorant onto said concrete pieces, and
d) drying said colored concrete pieces to form a concrete mulch.

13. The method of claim 12 further comprising the step of obtaining the concrete from waste concrete.

14. The method of claim 12 wherein said colorant is selected from the group consisting of iron oxide colorant, carbon black colorant and mixtures thereof.

15. The method of claim 12 wherein the colorant is present in an amount ranging from about 0.0025% to about 5% by weight of said concrete pieces.

16. The method of claim 12 wherein the amount of colorant added is from about 0.0025% to about 2% by weight of said concrete pieces.

17. The material of claim 12 wherein said binder is a polymer.

18. The material of claim 12 wherein said binder is a polyvinyl acetate.

19. The method of claim 12 wherein the amount of binder added is from about 0.0025% to about 5% by weight of said concrete pieces.

20. The method of claim 12 wherein the amount of binder added is from about 0.0025% to about 2% by weight of said concrete pieces.

21. A method for using waste concrete to form a landscaping ground cover comprising the steps of crushing waste concrete to form a plurality of concrete pieces having an outer surface with a rock like texture and a length ranging between about ⅛ inches and about 7 inches and a width ranging between about ⅛ inches and about 7 inches, coloring said crushed concrete pieces with an amount of colorant and binder so as to form a plurality colored concrete pieces, and drying said plurality of colored concrete pieces to form a concrete mulch imitating natural mulch.

22. The method of claim 21 wherein said waste concrete is obtained from demolished concrete airport runways, curb and gutter systems, interstate highway road beds, bridges, and buildings.
